(19) United States
(12) Patent Application Publication
(10) Pub. No.: US 2025/0103364 A1
(43) Pub. Date: Mar. 27, 2025

(54) RESOURCE ESTIMATION FOR MOBILE PACKET CORE CLOUD DEPLOYMENTS

(71) Applicant: MICROSOFT TECHNOLOGY LICENSING, LLC, Redmond, WA (US)

(72) Inventors: Steven Rhejohn Barlin SO, Burlington, MA (US); Philip TO, Burlington, MA (US); Tasneem NASEEM, Burlington, MA (US)

(21) Appl. No.: 18/371,158

(22) Filed: Sep. 21, 2023

(51) Int. Cl. G06F 9/455

(52) U.S. Cl. CPC G06F 9/45558; G06F 2009/45583; G06F 2009/45595

(57) ABSTRACT

Computing and network capacity are allocated in a computing environment provided by a virtualized computing service provider. An AI-based optimization model is run to quantify current network traffic in the computing environment based on processing and storage usage patterns using key performance indicators (KPIs). The quantified current network traffic is used to calculate, by a sizing and capacity model of the AI-based optimization model, a number, types, and sizes of disk storage and processing resources based on estimated cost.

### BACKGROUND

Next generation wireless networks have the promise to provide higher throughput, lower latency, and higher availability compared with previous global wireless standards. Telecommunication providers typically use private cloud deployments to host services. With the recent push to move those private cloud deployments to hybrid/public cloud deployments, a way to determine allocated resources for those telecommunication providers is important.

It is with respect to these considerations and others that the disclosure made herein is presented.

### SUMMARY

Network sizing to determine the computing resources necessary for wireless networks is typically performed manually. A typical sizing process is as follows: a team of engineers determines the necessary resource sizing given the specifications for a particular service and hardware, cross examines the cloud provider's current services to match the services accordingly, estimates the required resources, and computes the cost of deployment. This process is labor intensive and typically does not yield optimized estimates.

The present disclosure provides a way to automatically and continuously perform resource and cost estimation for hybrid or public cloud deployments without manual mediation from operators. A call model and traffic parameters (e.g., call volume) are used as inputs to a model that generates an optimal configuration with associated resource and cost estimates for users of mobile core deployments on cloud service providers.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2 is a diagram illustrating an example architecture in accordance with the present disclosure;

FIG. 3 is a diagram illustrating a data center and resources in accordance with the present disclosure;

FIG. 4 is a diagram illustrating an example architecture in accordance with the present disclosure:

FIG. 5 is a flowchart depicting an example procedure for provisioning resources in accordance with the present disclosure:

FIG. 6 is a flowchart depicting an example procedure for provisioning resources in accordance with the present disclosure:

FIG. 7 is an example computing system in accordance with the present disclosure.

### DETAILED DESCRIPTION

In a telecommunications network, one challenge is determining how to estimate capacity across the telecommunications network in a manner that optimizes the use of available resources in the network and at each edge site in order to achieve or optimize one or more objectives.

The present disclosure describes a dynamic resource optimizer that continuously determines the optimal cost of deployment in a telecommunications network. Telecommunication providers typically perform traffic analysis during periods when the network is at its peak traffic volume. Hence, resource estimates are generally allocated for the worst-case scenario and there is little adaptability of resource estimates when the network is not busy. The disclosed embodiments provide continuity of network analysis that enables a dynamically optimized resource solution. By allowing the resource allocations to dynamically scale up or down depending on the flow of traffic, user costs can be reduced as compared to sizing resources for the worst-case scenario. For example, resources can be allocated for short-term, intermediate-term, and long-term periods, with each being associated with different costs based on the optimal allocations for each period. In various embodiments, machine learning is used to optimally plan resource scheduling.

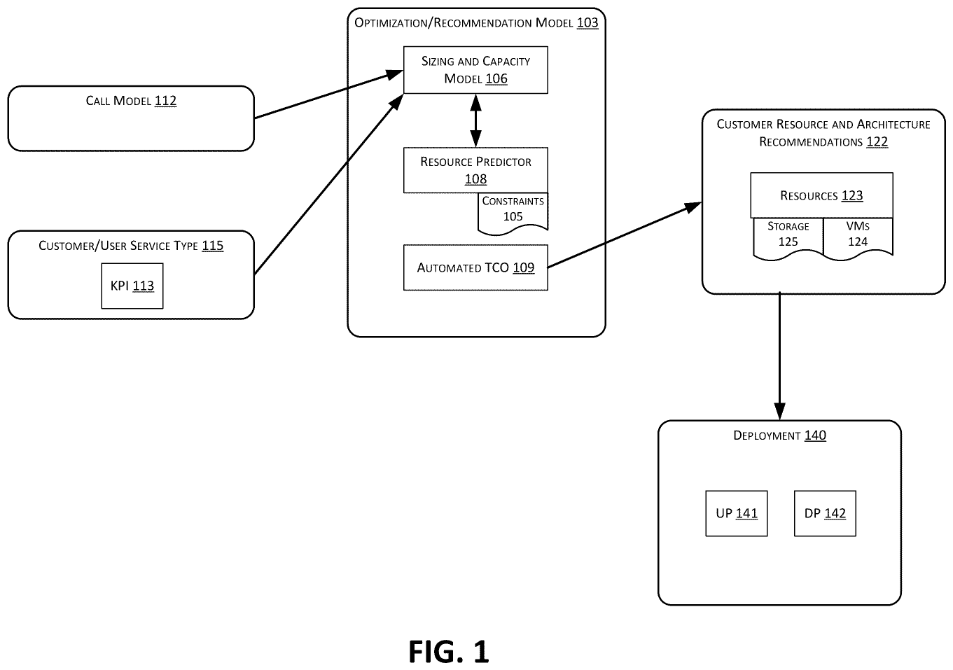

In an embodiment, an artificial intelligence (AI)-based optimization or recommendation model 103 is illustrated in FIG. 1. The inputs to the AI-based optimization or recommendation model 103 include a call model 112 and a customer service type or user service type 115. The AI-based optimization or recommendation model 103 quantifies current network traffic based on processing and storage usage patterns using key performance indicators (KPIs) 113 such as throughput per session, throughput per second, flow rate per Gbps for TCP, UDP, HTTP and HTTPS traffic. The call model is generally a representation of user behavior at a given site, and models and mimics the traffic type and volume during a given period of time.

In an embodiment, the KPIs 113 are used to calculate the size and number of virtual machines (VMs), containers, or other virtualized resources 123 that are required for a cloud deployment 140 of the user plane 141 and control plane 142. In some embodiments, the AI-based optimization or recommendation model 103 can include seasonal trends and can change annually, periodically, weekly, daily or even hourly. Seasonal trends are difficult to predict as the applications and seasonality can be customer and environment specific. Accordingly, in some embodiments a machine learning model is implemented to analyze the seasonality of the desired deployment. A trained machine learning model may be used to forecast seasonal network utilization where an optimal amount of resources is estimated to satisfy the deployment requirements. In an embodiment, the trained machine learning model can tracks the historical deployment requirements of the network.

The customer or user service type 115 includes customer specific requirements such as targeted number of sessions and throughput as well as the type of deployment (e.g., Control and User Plane Separation of EPC nodes (CUPS)/Integrated).

The AI-based optimization or recommendation model (103) includes a sizing and capacity model (106) that computes the number and size of VMs needed for deployment 140. The sizing and capacity model 106 works in a feedback cycle with a resource predictor 108 that dynamically calculates the optimal number, types, and sizes of disk storage 125 and processing (e.g., CPU) resources 123 based on cost and/or other constraints 105. The resource predictor 108 communicates with the sizing and capacity model 106 to determine an optimal number and type of VMs 124 based on the call models 112. The sizing and capacity model 106 determines the number and type of VMs 124 to optimize cost based on the network traffic or other constraints 105. In an embodiment, the sizing and capacity model 106 uses multi-output regression. In some embodiments, the resource predictor 108 uses multi-class classification techniques such as support vector machines, Gaussian discriminant analysis, or convolutional neural networks to determine the type of VM to use (e.g., A-series, B-series, D-series, E-series in Azure) based on expected memory and CPU consumption. In some embodiments, the capacity and sizing model 106 includes formulas developed based on domain expertise in wireless communication, field data from existing customers, and test data.

The resource predictor 108 interacts with the capacity and sizing model 106 to calculate the optimal number and type of VMs 124 based on changing call models 112. The number and type of VMs are selected based on the network traffic to provide optimized cost.

In an embodiment, the VMs are optimized for different purposes for memory and CPU consumption.

| VM Type | Usage |
|---|---|
| General Purpose | For a balanced CPU-to-memory ratio where |
| | the network traffic is well-balanced between |
| | throughput and sessions |
| Compute optimized | High CPU-to memory ratio where network |
| | traffic is processing large volumes of data. |
| | Optimal for ISM VMs that handle the traffic |
| | load. |
| Memory optimized | High memory-to-CPU ratio where network |
| | traffic is controlling a large number of |
| | sessions. Optimal for Control Plane |
| | Management VMs as they handle the |
| | memory required for the sessions. |

The automated total cost optimizer (TCO) 109 module takes the output from the resource predictor 108 and determines different types of cost:

Fixed—The TCO 109 uses a resource reservation function to provide the total cost of using service provider resources over a time period. For use cases where the model does not expect a significant change in the call model, the customer can allocate resources in bulk.

Seasonal—The calculated cost includes predicted changes in the call model that may require robustness and flexibility over time and include the cost of horizontal scaling.

The AI-based optimization or recommendation model 103 outputs customer resource and architecture recommendations 122 that can include resource allocation 123 such as VMs 124. The resource and architecture recommendations 122 can be sent to an orchestrator (not shown in FIG. 1) for cloud deployment 140 of the user plane 141 and control plane 142.

In some embodiments, the capacity and sizing model 106 can have at least two components. A trend component can model the basic resource usage trend over time. A periodic or seasonal component can model predictable changes for the resource usage based on the natural period of the metric (e.g., daily usage). The capacity and sizing model 106 may include a noise component that accounts for expected variations in the data. The capacity and sizing model 106 may also include an event-based component that represents effects due to the impact of an asynchronous or anomalous event. The event-based component can be used for various types of sudden events such as a customer reconfiguration.

In an embodiment, based on the output of the resource predictor 108, the recommendation data is automatically ingested into a cloud-based TCO calculator to output a trend line that shows predicted future costs.

In some embodiments, a reinforcement learning approach may be utilized to predict an optimal mapping between computing resources and a desired deployment based on historical data. The state (or input to a reinforcement learning algorithm) may comprise a historical time series for various parameters. The action (or output of the reinforcement learning algorithm) may comprise specific mappings between a desired deployment/configuration and resources. The reward function (or feedback received by the reinforcement learning algorithm) may comprise feedback from the communications network that indicates a mapping's quality. The reward function may comprise a function that penalizes, for example, higher cost and underutilized resources. The reinforcement learning algorithm may be encoded into a neural network that is trained to learn the mapping of states to actions so as to maximize the reward function.

In some embodiments, the disclosed embodiments may be implemented as a tool that can be used by data center operators for capacity planning. In an embodiment, the disclosed embodiments may be implemented as a tool for customers of the service provider. In some embodiments, the described techniques may be provided as a service that is accessible via a user interface. Such a user interface may be provided on a user computing device. The user interface may be provided in conjunction with an application that communicates to one or more systems that provide analysis of resource estimation. Some embodiments may use an application programming interface (API).

In some embodiments, the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provides federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

It should be appreciated that although the embodiments disclosed above are discussed in the context of virtual machines, other types of implementations can be utilized.

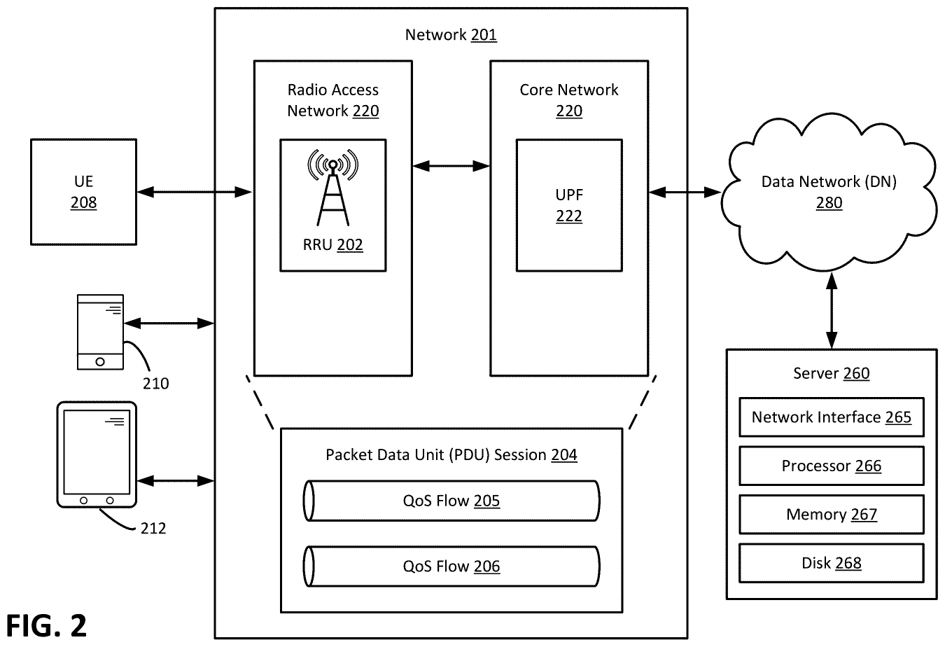

FIG. 2 depicts an embodiment of a network 201 (e.g., a 5G network) including a radio access network (RAN) 220 and a core network 220. The radio access network 220 may comprise a new-generation radio access network (NG-RAN) that uses the 5G new radio interface (NR). The network 201 electrically connects user equipment (UE) to the data network (DN) 280 using the radio access network 220 and the core network 220. The user equipment in communication with the radio access network 220 includes UE 208, mobile phone 210, and mobile computing device 212. The data network 280 may comprise the Internet, a local area network (LAN), a wide area network (WAN), a private data network, a wireless network, a wired network, or a combination of networks. The data network 280 may connect to or be in communication with server 260.

A server, such as server 260, may allow a client device, such as the mobile computing device 212, to download information or files (e.g., executable, text, application, audio, image, or video files) from the server. The server 260 may comprise a hardware server or a virtual server. In some cases, the server 260 may act as an application server or a file server. In general, a server may refer to a hardware device that acts as the host in a client-server relationship or to a software process that shares a resource with or performs work for one or more clients. The server 260 includes a network interface 265, processor 266, memory 267, and disk 268 all in communication with each other. Network interface 265 allows server 260 to connect to data network 280. Network interface 265 may include a wireless network interface and/or a wired network interface. Processor 266 allows server 260 to execute computer readable instructions stored in memory 267 in order to perform processes described herein. Processor 266 may include one or more processing units, such as one or more CPUs, one or more GPUs, and/or one or more NPUs. Memory 267 may comprise one or more types of memory (e.g., RAM, SRAM, DRAM, EEPROM, Flash, etc.). Disk 268 may include a hard disk drive and/or a solid-state drive. Memory 267 and disk 268 may comprise hardware storage devices.

The UE 208 may comprise an electronic device with wireless connectivity or cellular communication capability, such as a mobile phone or handheld computing device. In one example, the UE 208 may comprise a smartphone or a cellular device that connects to the radio access network 220 via a wireless connection. The UE 208 may comprise one of a plurality of UEs not depicted that are in communication with the radio access network 220. The UEs may include mobile and non-mobile computing devices. The UEs may include laptop computers, desktop computers, Internet-of-Things (IoT) devices, and/or any other electronic computing device that includes a wireless communications interface to access the radio access network 220.

The radio access network 220 includes a remote radio unit (RRU) 202 for wirelessly communicating with UE 208. The RRU 202 may comprise a radio unit (RU) and may include one or more radio transceivers for wirelessly communicating with UE 208. The RRU 202 may include circuitry for converting signals sent to and from an antenna of a base station into digital signals for transmission over packet networks. The radio access network 220 may correspond with a 5G radio base station that connects user equipment to the core network 220. The 5G radio base station may be referred to as a generation Node B, a “gNodeB,” or a “gNB.” A base station may refer to a network element that is responsible for the transmission and reception of radio signals in one or more cells to or from user equipment, such as UE 208.

A control plane (CP) may comprise a part of a network that controls how data packets are forwarded or routed. The control plane may be responsible for populating routing tables or forwarding tables to enable data plane functions. A data plane (or forwarding plane) may comprise a part of a network that forwards and routes data packets based on control plane logic. Control plane logic may identify packets to be discarded and packets to which a high quality of service should apply.

The core network 220 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In some cases, control plane functions may interact with each other using the service-based architecture. In some cases, a microservices-based architecture in which software is composed of small independent services that communicate over well-defined APIs may be used for implementing some of the core network functions. For example, control plane network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

In some cases, the primary core network functions may comprise the access and mobility management function (AMF), the session management function (SMF), and the user plane function (UPF). A UPF (e.g., UPF 222) may perform packet processing including routing and forwarding, quality of service (QOS) handling, and packet data unit (PDU) session management. The UPF may serve as an ingress and egress point for user plane traffic and provide anchored mobility support for user equipment. For example, the UPF 222 may provide an anchor point between the UE 208 and the data network 280 as the UE 208 moves between coverage areas. An AMF may act as a single-entry point for a UE connection and perform mobility management, registration management, and connection management between a data network and UE. An SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice may comprise an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements.

The network 201 may provide one or more network slices, wherein each network slice may include a set of network functions that are selected to provide specific telecommunications services. For example, each network slice may comprise a configuration of network functions, network applications, and underlying cloud-based compute and storage infrastructure. In some cases, a network slice may correspond with a logical instantiation of a wireless network, such as an instantiation of the network 201. User equipment, such as UE 208, may connect to one or more network slices at the same time. In one embodiment, a PDU session, such as PDU session 204, may belong to only one network slice instance. In some cases, the network 201 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

The core network 220 may include a plurality of network elements that are configured to offer various data and telecommunications services to subscribers or end users of user equipment, such as UE 208. Examples of network elements include network computers, network processors, networking hardware, networking equipment, routers, switches, hubs, bridges, radio network controllers, gateways, servers, virtualized network functions, and network functions virtualization infrastructure. A network element may comprise a real or virtualized component that provides wired or wireless communication network services.

Virtualization allows virtual hardware to be created and decoupled from the underlying physical hardware. One example of a virtualized component is a virtual router. Another example of a virtualized component is a virtual machine. A virtual machine may comprise a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors, the size of a virtual memory, and the size of a virtual disk for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The network 201 may implement various network functions, such as the core network functions and radio access network functions, using a cloud-based compute and storage infrastructure. A network function may be implemented as a software instance running on hardware or as a virtualized network function. Virtual network functions (VNFs) may comprise implementations of network functions as software processes or applications. In one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 2, the core network 220 includes a user plane function (UPF) 222 for transporting IP data traffic (e.g., user plane traffic) between the UE 208 and the data network 280 and for handling packet data unit (PDU) sessions with the data network 280. The UPF 222 may comprise an anchor point between the UE 208 and the data network 280. The UPF 222 may be implemented as a software process or application running within a virtualized infrastructure or a cloud-based compute and storage infrastructure. The network 201 may connect the UE 208 to the data network 280 using a packet data unit (PDU) session 204.

The PDU session 204 may utilize one or more quality of service (QOS) flows, such as QoS flows 205 and 206, to exchange traffic (e.g., data and voice traffic) between the UE 208 and the data network 280. The one or more QoS flows may comprise the finest granularity of QoS differentiation within the PDU session 204. The PDU session 204 may belong to a network slice instance through the network 201. To establish user plane connectivity from the UE 208 to the data network 280, an AMF that supports the network slice instance may be selected and a PDU session via the network slice instance may be established. In some cases, the PDU session 204 may be of type IPv4 or IPv6 for transporting IP packets.

The radio access network 220 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 208, over a geographic area.

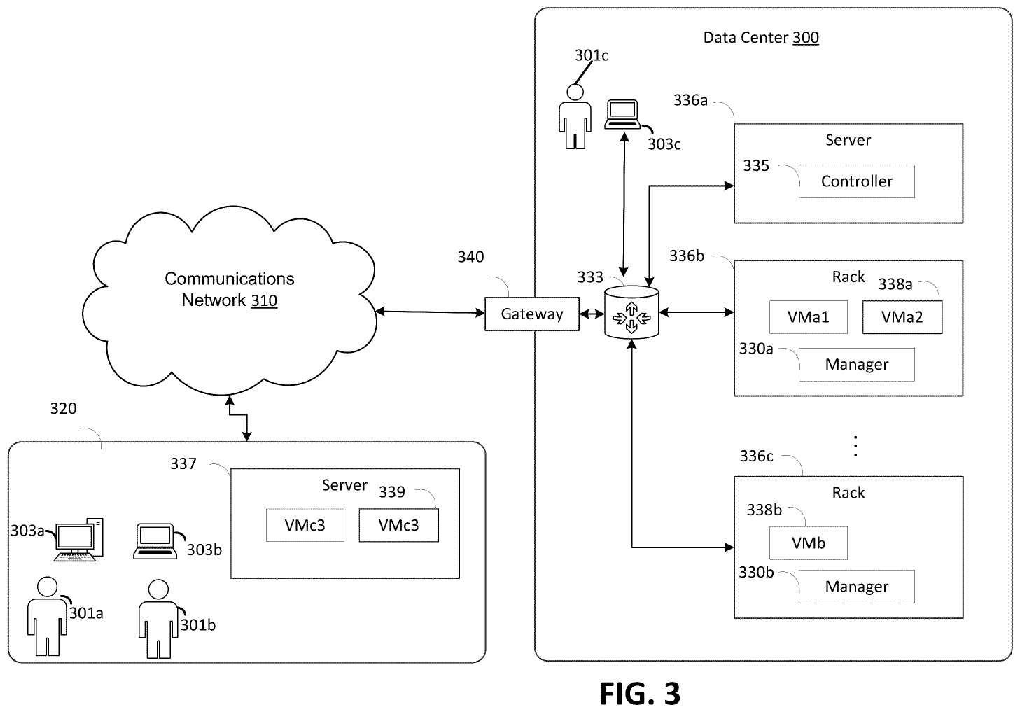

FIG. 3 illustrates an example computing environment in which the embodiments described herein may be implemented. FIG. 3 illustrates a data center 300 that is configured to provide computing resources to users 300a, 300b, or 300c (which may be referred herein singularly as “a user 301” or in the plural as “the users 301”) via user computers 303a, 303b, and 303c (which may be referred herein singularly as “a computer 303” or in the plural as “the computers 303”) via a communications network 310. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 300 may include servers 336a, 336b, and 336c (which may be referred to herein singularly as “a server 336” or in the plural as “the servers 336”) that may be standalone or installed in server racks, and provide computing resources available as virtual machines 338a and 338b (which may be referred to herein singularly as “a virtual machine 338” or in the plural as “the virtual machines 338”). The virtual machines 338 may be configured to execute applications such as Web servers, application servers, media servers, database servers, and the like. Other resources that may be provided include data storage resources (not shown on FIG. 3) and may include file storage devices, block storage devices, and the like. Servers 336 may also execute functions that manage and control allocation of resources in the data center, such as a controller 335. Controller 335 may be a fabric controller or another type of program configured to manage the allocation of virtual machines on servers 336.

Referring to FIG. 3, communications network 310 may, for example, be a publicly accessible network of linked networks and may be operated by various entities, such as the Internet. In other embodiments, communications network 310 may be a private network, such as a corporate network that is wholly or partially inaccessible to the public.

Communications network 310 may provide access to computers 303. Computers 303 may be computers utilized by users 301. Computer 303a, 303b or 303c may be a server, a desktop or laptop personal computer, a tablet computer, a smartphone, a set-top box, or any other computing device capable of accessing data center 300. User computer 303a or 303b may connect directly to the Internet (e.g., via a cable modem). User computer 303c may be internal to the data center 300 and may connect directly to the resources in the data center 300 via internal networks. Although only three user computers 303a, 303b, and 303c are depicted, it should be appreciated that there may be multiple user computers.

Computers 303 may also be utilized to configure aspects of the computing resources provided by data center 300. For example, data center 300 may provide a Web interface through which aspects of its operation may be configured through the use of a Web browser application program executing on user computer 303. Alternatively, a stand-alone application program executing on user computer 303 may be used to access an application programming interface (API) exposed by data center 300 for performing the configuration operations.

Servers 336 may be configured to provide the computing resources described above. One or more of the servers 336 may be configured to execute a manager 330a or 330b (which may be referred herein singularly as “a manager 330” or in the plural as “the managers 330”) configured to execute the virtual machines. The managers 330 may be a virtual machine monitor (VMM), fabric controller, or another type of program configured to enable the execution of virtual machines 338 on servers 336, for example.

It should be appreciated that although the embodiments disclosed above are discussed in the context of virtual machines, other types of implementations can be utilized with the concepts and technologies disclosed herein.

In the example data center 300 shown in FIG. 3, a network device 333 may be utilized to interconnect the servers 336a and 336b. Network device 333 may comprise one or more switches, routers, or other network devices. Network device 333 may also be connected to gateway 340, which is connected to communications network 310. Network device 333 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

FIG. 3 illustrates an edge site 320 that is geographically proximate to a facility local to users 301, in accordance with the present disclosure. In one embodiment, one or more servers 337 may be installed at the edge site 320. In an embodiment, servers 337 instantiate and run virtual machines 339.

In some embodiments, users 301 may specify configuration information for a virtual network to be provided for the user, with the configuration information optionally including a variety of types of information such as network addresses to be assigned to computing endpoints of the provided computer network, network topology information for the provided computer network, network access constraints for the provided computer network. The network addresses may include, for example, one or more ranges of network addresses, which may correspond to a subset of virtual or private network addresses used for the user's private computer network. The network topology information may indicate, for example, subsets of the computing endpoints to be grouped together, such as by specifying networking devices to be part of the provided computer network, or by otherwise indicating subnets of the provided computer network or other groupings of the provided computer network. The network access constraint information may indicate, for example, for each of the provided computer network's computing endpoints, which other computing endpoints may intercommunicate with the computing node endpoint, or the types of communications allowed to/from the computing endpoints.

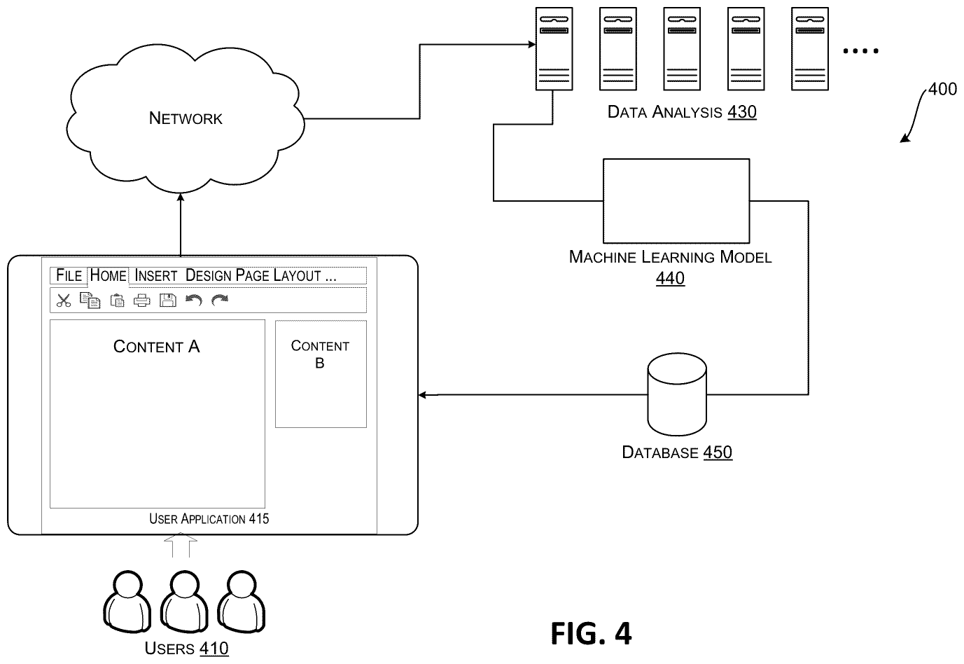

FIG. 4 is a computing system architecture diagram showing an overview of a system disclosed herein for implementing a machine learning model, according to one embodiment disclosed herein. As shown in FIG. 4, a machine learning system 400 may be configured to perform analysis and perform identification, prediction, or other functions based upon various data collected by and processed by data analysis components 430 (which might be referred to individually as an “data analysis component 430” or collectively as the “data analysis components 430”). The data analysis components 430 may, for example, include, but are not limited to, physical computing devices such as server computers or other types of hosts, associated hardware components (e.g., memory and mass storage devices), and networking components (e.g., routers, switches, and cables). The data analysis components 430 can also include software, such as operating systems, applications, and containers, network services, virtual components, such as virtual disks, virtual networks, and virtual machines. Database 450 can include data, such as a database, or a database shard (i.e., a partition of a database). Feedback may be used to further update various parameters that are used by machine learning model 440. Data may be provided to the user application 415 to provide results to various users 410 using a user application 415. In some configurations, machine learning model 440 may be configured to utilize supervised and/or unsupervised machine learning technologies.

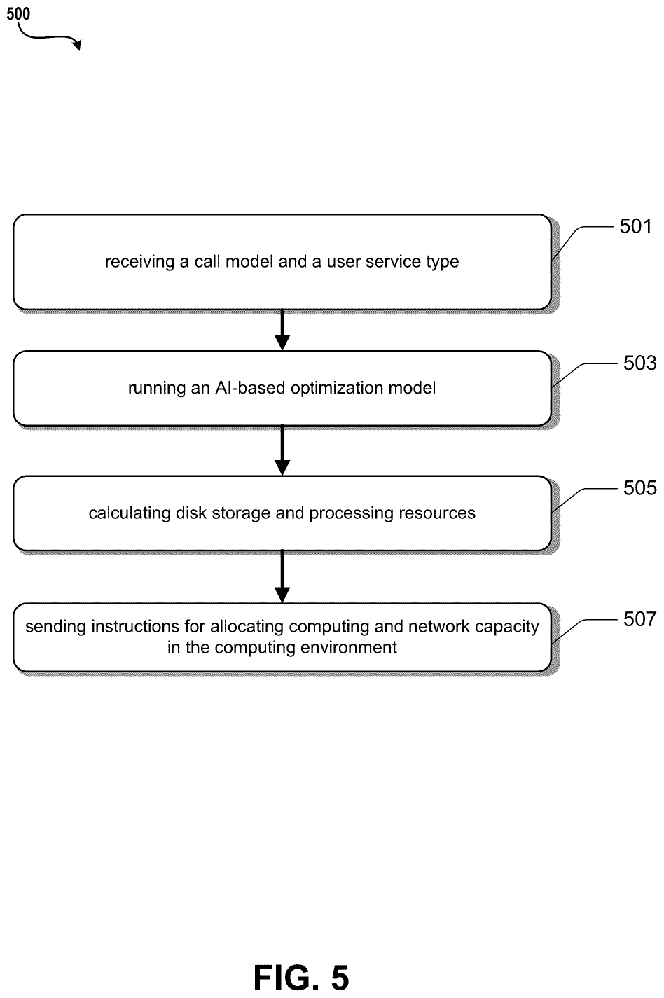

Turning now to FIG. 5, illustrated is an example operational procedure for provisioning network capacity in accordance with the present disclosure. Such an operational procedure can be provided by one or more components illustrated in FIGS. 1 through 4. The operational procedure may be implemented in a computing environment comprising a computing service provider.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 500 is described as running on a system, it can be appreciated that the routine 500 and other operations described herein can be executed on an individual computing device or several devices.

Referring to FIG. 5, operation 501 illustrates receiving a call model and a user service type.

Operation 503 illustrates running an AI-based optimization model.

Operation 505 illustrates using the quantified current network traffic to calculate, by a sizing and capacity model of the AI-based optimization model, a number, types, and sizes of disk storage and processing resources based on estimated cost, to deploy a user plane and control plane to deploy a service based on the call model and a user service type.

Operation 507 illustrates sending instructions for allocating computing and network capacity in the computing environment provided by the virtualized computing service provider.

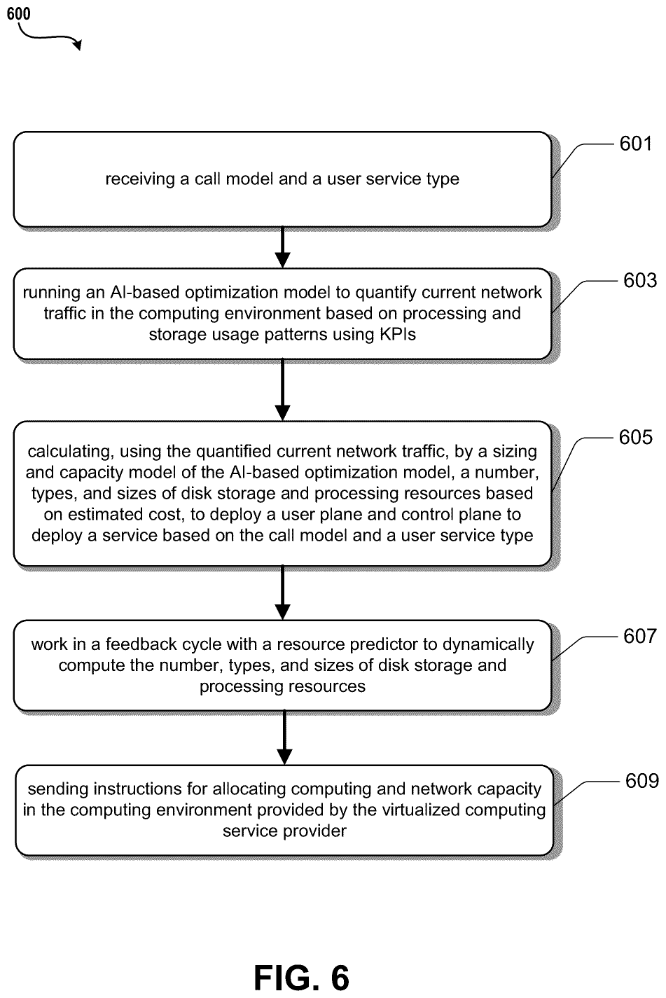

Turning now to FIG. 6, illustrated is an example operational procedure 600 for provisioning network capacity in accordance with the present disclosure. Referring to FIG. 6, operation 601 illustrates receiving a call model and a user service type.

Operation 603 illustrates running an AI-based optimization model to quantify current network traffic in the computing environment based on processing and storage usage patterns using key performance indicators (KPIs).

Operation 605 illustrates using the quantified current network traffic to calculate, by a sizing and capacity model of the AI-based optimization model, a number, types, and sizes of disk storage and processing resources based on estimated cost, to deploy a user plane and control plane to deploy a service based on the call model and a user service type.

Operation 607 illustrates the sizing and capacity model working in a feedback cycle with a resource predictor to dynamically compute the number, types, and sizes of disk storage and processing resources.

Operation 609 illustrates sending instructions for allocating computing and network capacity in the computing environment provided by the virtualized computing service provider.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like: c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

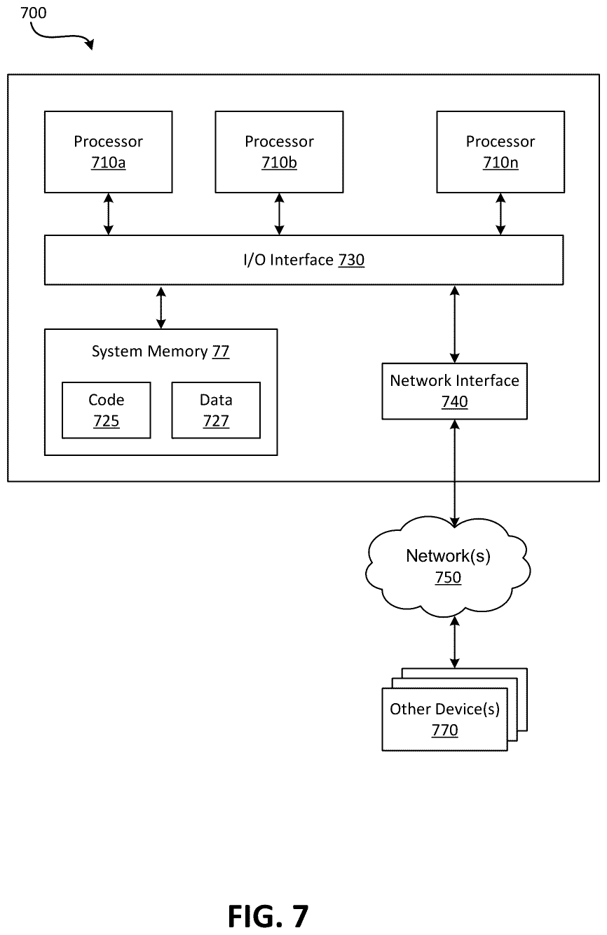

FIG. 7 illustrates a general-purpose computing device 700. In the illustrated embodiment, computing device 700 includes one or more processors 710a, 710b, and/or 710n (which may be referred herein singularly as “a processor 710” or in the plural as “the processors 710”) coupled to a system memory 77 via an input/output (I/O) interface 730. Computing device 700 further includes a network interface 740 coupled to I/O interface 730.

In various embodiments, computing device 700 may be a uniprocessor system including one processor 710 or a multiprocessor system including several processors 710 (e.g., two, four, eight, or another suitable number). Processors 710 may be any suitable processors capable of executing instructions. For example, in various embodiments, processors 710 may be general-purpose or embedded processors implementing any of a variety of instruction set architectures (ISAs), such as the x77, PowerPC, SPARC, or MIPS ISAs, or any other suitable ISA. In multiprocessor systems, each of processors 710 may commonly, but not necessarily, implement the same ISA.

System memory 77 may be configured to store instructions and data accessible by processor(s) 710. In various embodiments, system memory 77 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 720 as code 725 and data 727.

In one embodiment, I/O interface 730 may be configured to coordinate I/O traffic between the processor 710, system memory 77, and any peripheral devices in the device, including network interface 740 or other peripheral interfaces. In some embodiments, I/O interface 730 may perform any necessary protocol, timing, or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components. Also, in some embodiments some or all of the functionality of I/O interface 730, such as an interface to system memory 720, may be incorporated directly into processor 710.

Network interface 740 may be configured to allow data to be exchanged between computing device 700 and other device or devices 770 attached to a network or network(s) 750, such as other computer systems or devices as illustrated in FIGS. 1 through 4, for example. In various embodiments, network interface 740 may support communication via any suitable wired or wireless general data networks, such as types of Ethernet networks, for example. Additionally, network interface 740 may support communication via telecommunications/telephony networks such as analog voice networks or digital fiber communications networks, via storage area networks such as Fibre Channel SANs or via any other suitable type of network and/or protocol.

In some embodiments, system memory 720 may be one embodiment of a computer-accessible medium configured to store program instructions and data as described above for FIGS. 1-6 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 700 via I/O interface 730. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 700 as system memory 720 or another type of memory. Further, a computer-accessible medium may include transmission media or signals such as electrical, electromagnetic or digital signals, conveyed via a communication medium such as a network and/or a wireless link, such as may be implemented via network interface 740. Portions or all of multiple computing devices, such as those illustrated in FIG. 7, may be used to implement the described functionality in various embodiments: for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 7, may include other components that are not explicitly shown in FIG. 7, or may utilize an architecture completely different than that shown in FIG. 7.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms: furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for allocating computing and network capacity in a telecommunications network environment provided by a virtualized computing service provider, the method comprising:
receiving a call model and a user service type;
running an AI-based optimization model to quantify current network traffic in the telecommunications network environment based on processing and storage usage patterns using key performance indicators (KPIs);
calculating, using the quantified current network traffic by a sizing and capacity model of the AI-based optimization model, a number, types, and sizes of disk storage and processing resources based on estimated cost, wherein the number, types, and sizes of disk storage and processing resources are usable to deploy a user plane and control plane to implement a network service based on the call model and user service type, wherein the sizing and capacity model operates in a feedback cycle with a resource predictor to dynamically compute the number, types, and sizes of disk storage and processing resources; and
sending instructions for allocating, in accordance with the calculated number, types, and sizes of disk storage and processing resources, computing and network capacity in the telecommunications network environment.

Clause 2: The method of clause 1, wherein the AI-based optimization model includes a seasonality of the call model and user service type.

Clause 3: The method of any of clauses 1-2, wherein the user service type includes one or more of targeted number of sessions, throughput, or type of deployment.

Clause 4: The method of any of clauses 1-3, wherein the sizing and capacity model uses multi-output regression.

Clause 5: The method of any of clauses 1-4, wherein the resource predictor uses multi-class classification.

Clause 6: The method of any of clauses 1-5, wherein the multi-class classification is one of support vector machines, Gaussian discriminant analysis, or convolutional neural networks.

Clause 7: The method of clauses 1-6, wherein the processing resources include virtual machines (VMs).

Clause 8: The method of any of clauses 1-7, wherein the VMs are optimized for processing and storage consumption based on a VM type comprising one or more of general purpose, compute optimized, or memory optimized.

Clause 9: The method of any of clauses 1-8, wherein an automated total cost optimizer (TCO) module receives an output from the resource predictor to determine the estimated cost.

Clause 10: The method of any of clauses 1-9, wherein the estimated cost is one of a fixed cost or a seasonal cost.

Clause 11: A system for allocating computing and network capacity in a computing environment provided by a virtualized computing service provider, the system comprising:
one or more processors; and
a memory in communication with the one or more processors, the memory having computer-readable instructions stored thereupon that, when executed by the one or more processors, cause the system to perform operations comprising:
receiving a call model and a user service type;
running an AI-based optimization model to quantify current network traffic in the computing environment based on processing and storage usage patterns using key performance indicators (KPIs);
using the quantified current network traffic to calculate, by a sizing and capacity model of the AI-based optimization model, a number, types, and sizes of disk storage and processing resources based on estimated cost to deploy a user plane and control plane to implement a network service based on the call model and a user service type; and
sending instructions for allocating, in accordance with the number, types, and sizes of disk storage and processing resources, computing and network capacity in the computing environment provided by the virtualized computing service provider.

Clause 12: The system of clause 11, wherein the sizing and capacity model works in a feedback cycle with a resource predictor to dynamically compute the number, types, and sizes of disk storage and processing resources.

Clause 13: The system of any of clauses 11 and 12, wherein the AI-based optimization model includes a seasonality of the call model and user service type.

Clause 14: A computer-readable storage medium having computer-executable instructions for allocating computing and network capacity in a computing environment provided by a virtualized computing service provider, the computer-readable storage medium having computer-executable instructions stored thereupon which, when executed by one or more processors of a computing device, cause the computing device to perform operations comprising:
receiving a call model and a user service type;
running an AI-based optimization model to quantify current network traffic in the computing environment based on processing and storage usage patterns using key performance indicators (KPIs);
using the quantified current network traffic to calculate, by a sizing and capacity model of the AI-based optimization model, a number, types, and sizes of disk storage and processing resources based on estimated cost to deploy a user plane and control plane to deploy a service based on the call model and a user service type; and
sending instructions for allocating, based on the number, types, and sizes of disk storage and processing resources, computing and network capacity in the computing environment provided by the virtualized computing service provider.

Clause 15: The computer-readable storage medium of clause 14, wherein the sizing and capacity model works in a feedback cycle with a resource predictor to dynamically compute the number, types, and sizes of disk storage and processing resources.

Clause 16: The computer-readable storage medium of any of clauses 14 and 15, wherein the AI-based optimization model includes a seasonality of the call model and user service type.

Clause 17: The computer-readable storage medium of any of the clauses 14-16, wherein the user service type includes one or more of targeted number of sessions, throughput, or type of deployment.

Clause 18: The computer-readable storage medium of any of the clauses 14-17, wherein the sizing and capacity model uses multi-output regression.

Clause 19: The computer-readable storage medium of any of the clauses 14-18, wherein the resource predictor uses multi-class classification.

Clause 20: The computer-readable storage medium of any of the clauses 14-19, wherein the multi-class classification is one of support vector machines. Gaussian discriminant analysis, or convolutional neural networks.

1. A method for allocating computing and network capacity in a telecommunications network environment provided by a virtualized computing service provider, the method comprising:
receiving a call model and a user service type;
running an AI-based optimization model to quantify current network traffic in the telecommunications network environment based on processing and storage usage patterns using key performance indicators (KPIs);
calculating, using the quantified current network traffic by a sizing and capacity model of the AI-based optimization model, a number, types, and sizes of disk storage and processing resources based on estimated cost, wherein the number, types, and sizes of disk storage and processing resources are usable to deploy a user plane and control plane to implement a network service based on the call model and user service type, wherein the sizing and capacity model operates in a feedback cycle with a resource predictor to dynamically compute the number, types, and sizes of disk storage and processing resources; and
sending instructions for allocating, in accordance with the calculated number, types, and sizes of disk storage and processing resources, computing and network capacity in the telecommunications network environment.

2. The method of claim 1, wherein the AI-based optimization model includes a seasonality of the call model and user service type.

3. The method of claim 1, wherein the user service type includes one or more of targeted number of sessions, throughput, or type of deployment.

4. The method of claim 1, wherein the sizing and capacity model uses multi-output regression.

5. The method of claim 1, wherein the resource predictor uses multi-class classification.

6. The method of claim 5, wherein the multi-class classification is one of support vector machines, Gaussian discriminant analysis, or convolutional neural networks.

7. The method of claim 1, wherein the processing resources include virtual machines (VMs).

8. The method of claim 7, wherein the VMs are optimized for processing and storage consumption based on a VM type comprising one or more of general purpose, compute optimized, or memory optimized.

9. The method of claim 1, wherein an automated total cost optimizer (TCO) module receives an output from the resource predictor to determine the estimated cost.

10. The method of claim 9, wherein the estimated cost is one of a fixed cost or a seasonal cost.

11. A system for allocating computing and network capacity in a computing environment provided by a virtualized computing service provider, the system comprising:
one or more processors; and
a memory in communication with the one or more processors, the memory having computer-readable instructions stored thereupon that, when executed by the one or more processors, cause the system to perform operations comprising:
receiving a call model and a user service type;
running an AI-based optimization model to quantify current network traffic in the computing environment based on processing and storage usage patterns using key performance indicators (KPIs);
using the quantified current network traffic to calculate, by a sizing and capacity model of the AI-based optimization model, a number, types, and sizes of disk storage and processing resources based on estimated cost to deploy a user plane and control plane to implement a network service based on the call model and a user service type; and
sending instructions for allocating, in accordance with the number, types, and sizes of disk storage and processing resources, computing and network capacity in the computing environment provided by the virtualized computing service provider.

12. The system of claim 11, wherein the sizing and capacity model works in a feedback cycle with a resource predictor to dynamically compute the number, types, and sizes of disk storage and processing resources.

13. The system of claim 11, wherein the AI-based optimization model includes a seasonality of the call model and user service type.

14. A computer-readable storage medium having computer-executable instructions for allocating computing and network capacity in a computing environment provided by a virtualized computing service provider, the computer-readable storage medium having computer-executable instructions stored thereupon which, when executed by one or more processors of a computing device, cause the computing device to perform operations comprising:
receiving a call model and a user service type;
running an AI-based optimization model to quantify current network traffic in the computing environment based on processing and storage usage patterns using key performance indicators (KPIs);
using the quantified current network traffic to calculate, by a sizing and capacity model of the AI-based optimization model, a number, types, and sizes of disk storage and processing resources based on estimated cost to deploy a user plane and control plane to deploy a service based on the call model and a user service type; and
sending instructions for allocating, based on the number, types, and sizes of disk storage and processing resources, computing and network capacity in the computing environment provided by the virtualized computing service provider.

15. The computer-readable storage medium of claim 14, wherein the sizing and capacity model works in a feedback cycle with a resource predictor to dynamically compute the number, types, and sizes of disk storage and processing resources.

16. The computer-readable storage medium of claim 14, wherein the AI-based optimization model includes a seasonality of the call model and user service type.

17. The computer-readable storage medium of claim 14, wherein the user service type includes one or more of targeted number of sessions, throughput, or type of deployment.

18. The computer-readable storage medium of claim 14, wherein the sizing and capacity model uses multi-output regression.

19. The computer-readable storage medium of claim 15, wherein the resource predictor uses multi-class classification.

20. The computer-readable storage medium of claim 19, wherein the multi-class classification is one of support vector machines, Gaussian discriminant analysis, or convolutional neural networks.
